(19) United States
(12) Patent Application Publication
(10) Pub. No.: US 2024/0384372 A1
(43) Pub. Date: Nov. 21, 2024

(54) COAL AND RARE EARTH RECOVERY METHOD AND SYSTEM

(71) Applicant: Jeffrey MOLESEVICH, Kulpmont, PA (US)

(72) Inventor: Jeffrey MOLESEVICH, Kulpmont, PA (US)

(21) Appl. No.: 18/664,967

(22) Filed: May 15, 2024

Related U.S. Application Data
(60) Provisional application No. 63/503,256, filed on May 19, 2023.

(51) Int. Cl. C22B 59/00; C22B 1/24; C22B 3/04; C22B 3/22

(52) U.S. Cl. CPC C22B 59/00; C22B 1/24; C22B 3/04; C22B 3/22

(57) ABSTRACT

A coal and rare earth recovery system and method to recover rare earth materials from coal material source and from coal material and process water. The method includes providing a coal material feed and separating the coal material feed to produce a clean prepared coal stream, a coarse rock refuse stream and a first fine rock refuse stream. The coarse rock refuse stream may be processed to form a second fine rock refuse stream. The first fine rock refuse stream and the second fine rock refuse stream are fed to a rare earth element recovery unit to process the first fine rock refuse stream and the second fine rock refuse stream to recover a rare earth material. In addition, processes and systems for processing acid mine drainage streams and processed waste streams with a rare earth element recovery unit to recover a rare earth material are disclosed.

### CROSS REFERENCE TO RELATED APPLICATIONS

This application is a non-provisional patent application claiming priority and benefit of U.S. Provisional Patent Application No. 63/503,256, filed May 19, 2023, entitled “COAL AND RARE EARTH RECOVERY SYSTEM”, currently pending, which is hereby incorporated by reference in its entirety.

### FIELD OF THE INVENTION

The present disclosure is generally directed to a method and system for recovery of coal and rare earth materials from coal-containing materials.

### BACKGROUND OF THE INVENTION

Rare earth elements (REEs) play essential roles in numerous industries, including the production of batteries for hybrid and electric vehicles, catalytic converters, computer memory, fluorescent lighting, lasers, smartphones, tablet computers, cameras, e-readers, magnets, night-vision goggles, GPS systems, communications equipment, military hardware like precision-guided weapons and vehicle armor, aircraft engines, personal protective gear, and various defense applications. Additionally, certain REEs find applications in air pollution control, oil refining, medical diagnostics (such as X-ray and MRI machines), as phosphors, catalysts, ceramic and paint constituents, and polishing agents. While REEs and other valuable minerals can be extracted from ores, only a limited number of these resources are economically viable. China dominates the current worldwide REEs mine production but has strategically restricted its exports of REEs, causing significant instability for the market. In response to the increasing global demand and the supply dominance of China, finding alternative sources of REEs have become a critical national security issue for other countries, including the United States. Given existing and potential export restrictions on REEs from China, there is a growing interest in developing domestic sources of these vital elements.

Coal varies considerably from mine to mine. Coal types that are mined in the United States include anthracite, bituminous coal, sub-bituminous coal and lignite. Anthracite is the highest rank coal with a high carbon content and low volatile matter, which is used typically in heating for homes and for industrial uses. Bituminous coal is the most abundant type of coal in the United States and has a high heat content and is used in electricity generation, steel production, and as a fuel for industrial processes. Sub-bituminous coal is a type of coal with a lower heat content compared to bituminous coal but is still widely used for electricity generation due to its abundance and relatively lower sulfur content. Lignite is the lowest rank of coal and has the lowest heat content and is used in electricity generation, primarily in power plants located near the coal mines due to its low energy density and high moisture content. The various ranks of coal are more or less efficient when used in thermal processes such as gasification or boiler firing. For example, coal with a higher energy density, such as anthracite, (e.g., larger BTU/pound or joule/kg) has greater value.

Historically speaking, past coal preparation plants depending on the era, had inefficiencies to recover saleable coal. On average, a preparation plant in the early 1900's may have only been 75-85% efficient leaving 15 to 25% of saleable coal mixed with the plants rock reject. Typically, mine refuse piles older than 1900 may have higher percentages of recoverable coal due to lack of technology whereas refuse piles created in the 1950's would have much less recoverable coal. Accordingly, there are large stockpiles of refuse piles (culm, silt, gob, tailings, rejects, etc.) having significant amounts of valuable carbon products that may be recovered utilizing more modern coal recovery processes. Likewise, these refuse piles have significant amounts of other materials, such as rare earth elements, that have significant value, particularly in areas where rare earth materials are otherwise scarce. No known processes have been able to economically recover rare earth element containing materials from coal waste materials.

Another waste material that includes rare earth material include mine pool water or acid mine drainage (AMD). AMD is a pollutant generated by coal and other mines and must be treated in compliance with federal and state clean water regulations. Such treatments require pH adjustment and removal of metal ions, such as iron, aluminum and manganese. The Appalachian regions as well as other mining areas across the United States, include significant AMD. Water pollution caused by AMD is a significant issue with respect to stream degradation and impairment. Although it is known that trace amounts of REEs are known to exist in AMD, no known economically viable process for extracting REEs is currently known.

What is needed is a system and method to recover saleable coal and rare earth materials that yields commercial quantities of rare earth from domestic feedstocks that doesn't suffer from the drawbacks of the prior art. Other features and advantages will be made apparent from the present specification. The teachings disclosed extend to those embodiments that fall within the scope of the claims, regardless of whether they accomplish one or more of the aforementioned needs.

### SUMMARY OF THE INVENTION

Embodiments according to the present disclosure include a method and system for recovery of rare earth materials utilizing coal-containing materials or coal material source, such as refuse byproducts from a rock and coal feedstock, mined coal and/or mine pool water (e.g., acid mine drainage).

An embodiment of the present disclosure includes a coal and rare earth recovery system to recover rare earth materials from a coal material source. The coal and rare earth recover system includes a coal preparation unit arranged and disposed to process a coal material source into a clean prepared coal stream, a coarse rock refuse stream and a first fine rock refuse stream. A coarse rock refuse processing unit is arranged and disposed to receive the coarse rock refuse stream and discharge a second fine rock refuse stream. The coal and rare earth recovery system also includes a rare earth element recovery unit to process the first fine rock refuse stream and the second fine rock refuse stream to recover a rare earth material.

Another embodiment of the present disclosure includes a method for coal and rare earth recovery. The method includes providing a coal material feed and separating the coal material feed to produce a clean prepared coal stream, a coarse rock refuse stream and a first fine rock refuse stream. The method also includes washing the clean prepared coal stream to form a washed clean prepared coal stream and dewatering the washed clean prepared coal stream to form a clean prepared coal. The coarse rock refuse stream is processed to form a second fine rock refuse stream. The first fine rock refuse stream and the second fine rock refuse stream are fed to a rare earth element recovery unit to process the first fine rock refuse stream and the second fine rock refuse stream to recover a rare earth material.

Another embodiment of the present disclosure includes a rare earth recovery system to recover rare earth materials from a coal material source and process water. The system includes a process water source and a coal preparation unit arranged and disposed to receive a process water stream from the process water source to process a coal material feed and discharge a water and ultrafine coal refuse stream. The system also includes an acid mine pool arranged and disposed to receive the water and ultrafine coal refuse stream from the coal preparation unit and a rare earth element recovery unit arranged and disposed to process an acid mine drainage stream from the acid mine pool to recover a rare earth material.

Another embodiment of the present disclosure includes a method for coal and rare earth recovery from a coal material source and process water. The method includes providing a process water source. A coal material is processed with a coal preparation unit, the coal preparation unit discharging a water and ultrafine coal refuse stream to an acid mine pool. An acid mine drainage stream is fed from the acid mine pool to a rare earth element recovery unit. The acid mine drainage stream is processed with the rare earth element recovery unit to recover a rare earth material.

Another embodiment of the present disclosure includes a coal and rare earth recovery system to recover rare earth materials from coal material source. The system includes a coal preparation unit arranged and disposed to separate a coal material source into a clean prepared coal stream, a coarse rock refuse stream and a first fine rock refuse stream. A coal processing unit is arranged and disposed to receive one or more of the clean prepared coal stream, the coarse rock refuse stream and the first fine rock refuse stream, process the one or more of the clean prepared coal stream, the coarse rock refuse stream and the first fine rock refuse stream and discharge a converted coal product and a processed waste stream. A rare earth element recovery unit is arranged and disposed to process the processed waste stream to recover a rare earth material.

Another embodiment of the present disclosure includes a method for a method for recovering coal and rare earth material from coal material source. The method includes separating a coal material source into a clean prepared coal stream, a coarse rock refuse stream and a first fine rock refuse stream. The clean prepared coal stream, the coarse rock refuse stream, and/or the fine rock refuse stream processed to form a converted coal product and a processed waste stream. The processed waste stream is processed with a rare earth element recovery unit to recover a rare earth material.

Other features and advantages of the present invention will be apparent from the following more detailed description of the preferred embodiment, taken in conjunction with the accompanying drawings which illustrate, by way of example, the principles of the invention.

### BRIEF DESCRIPTION OF DRAWINGS

FIG. 1 illustrates a coal and rare earth recovery system according to the present disclosure.

FIG. 2 illustrates a coal and rare earth recovery system according to another embodiment of the present disclosure including an expanded view of an example of a coal preparation unit.

FIG. 3 illustrates a coal and rare earth recovery system according to another embodiment of the present disclosure including an acid mine drainage source.

FIG. 4 illustrates a coal and rare earth recovery system according to another embodiment of the present disclosure including an acid mine pool.

FIG. 5 illustrates a coal and rare earth recovery system according to another embodiment of the present disclosure including a coal processing unit.

FIG. 6 illustrates a process flow for a system according to an embodiment of the present disclosure.

FIG. 7 illustrates a process flow for a system according to another embodiment of the present disclosure including a step of feeding AMD material to the rare earth recovery unit.

FIG. 8 illustrates a process flow for a system according to another embodiment of the present disclosure including discharging acid mine drainage from an acid mine pool to the rare earth recovery unit.

FIG. 9 illustrates a process flow for a system according to another embodiment of the present disclosure including a coal processing unit.

Wherever possible, the same reference numbers will be used throughout the drawings to represent the same parts.

### DETAILED DESCRIPTION OF THE INVENTION

Systems and methods according to the present disclosure recover rare earth materials, including rare earth element-containing materials or rare earth materials (REMs), from waste materials, including coal containing material, in sufficient quantities to provide a commercial benefit. Another embodiment of the disclosure includes both coal separation and REMs recovery utilizing acid mine drainage (i.e., mine pool water). An objective of the method and system according to the present disclosure is to capture the REMs after the coal has been washed and prepared.

In addition, in one embodiment according to the present disclosure, the system utilizes, in addition to the basic coal processing steps and REMs recovery system, the ability to integrate a Coal-to-Gas (CTG), Coal-to-Liquid (CTL) circuit or chemical processes. The coal conversion CTG and/or CTL circuit may be added after the coal is separated from non-carbon impurities enabling the REMs circuit to continue untouched while an added value is being created on the coal stream. During a coal conversion process, more liberation of rare earth elements takes place. REM may be bonded or ingrained within coal and coal containing materials, which may be liberated by processes, such as CTG, CTL or chemical processes, wherein mechanical processes alone are insufficient.

An embodiment of the present disclosure includes a coal and rare earth recovery system 100 to recover rare earth materials from a coal material source. The coal material source may include any suitable coal product, previously processed or mined. A particularly suitable coal material may include mine refuse also known as (culm, silt, gob, tailings, rejects, etc.). The mine refuse in this embodiment includes a combination of a certain percentage of coal and rock that was a byproduct of a past and/or present coal preparation facility. For example, these byproducts, such as anthracite culm may include up to about 20% or up to about 25% or up to about 30% by weight carbon. In contrast, where the coal material utilized is mined anthracite coal, the anthracite coal may include up to about 80% or up to about 85% or up to about 90% by weight carbon. Embodiments of the present disclosure includes an integrated coal and rare earth element recovery system that utilize mine refuse byproducts as a feed source. In other embodiments, the integrated coal and rare earth element recovery system may utilize mined coal, by methods of strip, deep, and/or longwall mining but not limited to future advancements in techniques to extract the coal, including, but not limited to, anthracite and bituminous coal as a feed source. In certain embodiments, the system according to the present disclosure is a fully integrated coal and rare earth element recovery plant. In certain embodiments, the coal material source may contain previously processed or mined anthracite, bituminous coal, sub-bituminous coal and/or lignite. Combinations of mined coal and mine refuse may also be utilized as coal material.

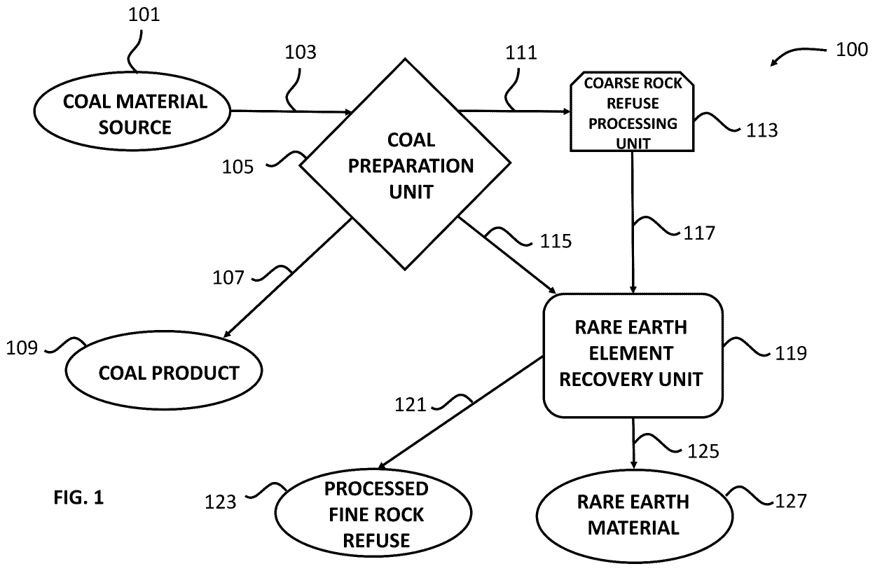

FIG. 1 shows a coal and rare earth recovery system 100 according to the present disclosure. The coal and rare earth recovery system 100 includes a coal material source 101, which includes processed or mined coal materials. The coal material source 101 may be a hopper or other material handling unit capable of feeding an unprepared plant feed 103, or coal material feed, to a coal preparation unit 105. In other embodiments the coal material source 101 may be stored or piled mine refuse, such as mine culm, silt, gob, tailings, rejects, or other mine refuse that has been previously processed. The coal preparation unit 105 includes processes to clean and separate the unprepared plant feed 103 into a clean prepared coal stream 107, a coarse rock refuse stream 111, a first fine rock refuse stream 115. The coal preparation unit 105 performs processes to generate the three different streams, including the coarse rock refuse stream 111, the first fine coarse rock refuse stream 115 and the clean prepared coal stream 107. The processes may include, for example, washing, crushing and separation operations. For example, the process may include water washing and/or dense media separation processes, such as with cyclones, drums, baths and/or other heavy media gravity separation processes. The clean prepared coal is captured as a commercial coal product that may be separated and sized as a commercial product. The clean prepared coal is sorted over a series of vibrating screens and sized for saleable markets. The clean prepared coal stream 107 may be further processed by sizing or other mechanical processes to provide a sized coal product 109. The coarse rock refuse stream 111 is fed to a coarse rock refuse processing unit 113, which crushes or otherwise processes the coarse rock refuse stream 111 into a second fine rock refuse stream 117. The second fine rock refuse stream 117 from the coarse rock refuse processing unit 113 and the first fine rock refuse stream 115 are fed to a rare earth element recovery unit 119.

The coarse rock refuse stream 111 and the first fine rock refuse streams 115 are material streams that, in known systems, would have been stockpiled or otherwise stored as waste. The coarse rock refuse stream 111 and the first fine rock refuse stream 115 are “rejected” from the coal preparation unit 105 into feeds streams for the rare earth element recovery unit 119. The sizes in these streams after the coal is separated from the rock is half millimeter (0.5 mm) by zero (0) “Fines Reject” (i.e., the fine rock refuse stream) and half millimeter by one and a half inches plus (1½″+) “Coarse Reject” (i.e., the coarse rock refuse). In larger cleaning circuits, larger material can be handled. In certain embodiments, the sizes in the coarse rock refuse stream 111 and may include particle sizes of up to 1½″ or up to 2″ or up to 2½″ or up to 3″ or more. Depending on the specific rare earth element recovery system implemented, the coarse rock may need to be crushed/pulverized to liberate the elements from the aggregate or shale (e.g., in the crusher/pulverizer) and enabling the system to more efficiently extract REMs within the coarse pieces. In those embodiments, according to the present disclosure, the coarse rock refuse is fed to a coarse rock refuse processing unit 113, such as a crusher/pulverizer, to crush or pulverize the coarse rock refuse into the size of the fine rock refuse stream. After sizing to the fine rock refuse size, the crushed/pulverized material is fed to a rare earth element recovery unit 119. Similarly, the fine rock refuse stream from the coal preparation unit 105 is fed to the rare earth element recovery unit 119.

The rare earth element recovery unit 119 utilizes chemical and mechanical processes to recover and concentrate rare earth elements in materials to form a rare earth material stream 125 and a rare earth material 127. The rare earth element recovery unit 119 also produces a processed fine rock refuse stream 121 that is accumulated and/or stored for disposal or reclamation as processed fine rock refuse 123.

By “recover”, “recovery”, “recovering” and grammatical variations thereof, as utilized herein with respect to the rare earth element recovery unit 119, the rare earth materials (REMs) are to be captured, separated, recovered and/or concentrated in the rare earth element recovery unit 119 of the coal and rare earth recovery system 100. As used herein, the term “rare earth material” or “REM” refers to a composition, material or other article comprising one or more rare earth elements (REEs), including one or more of a lanthanide chemical element, e.g., Neodymium (Nd), Lanthanum (La), Yttrium (Y), Cerium (Ce), Scandium (Sc), Praseodymium (Pr), Dysprosium (Dy), Terbium (Tb), Samarium (Sm), Europium (Eu), Erbium (Er), Gadolinium (Gd), Holmium (Ho), Lutetium (Lu), Thulium (Tm), Ytterbium (Yb), and Promethium (Pm). In addition, the rare earth material may include the elements scandium and yttrium. Rare earth materials may include oxides of rare earth elements. It is to be understood that when referencing rare earth elements that any of the elements can be present in a zero valence or elemental state, or in an ionized or valence state associated in the art with the individual element, and all forms are understood to be collectively included within the meaning of “rare earth materials”. Moreover, it is to be understood that reference to any individual rare earth element, can be present in a zero valence or elemental state, or in an ionized or valence state associated in the art with the given element, and all forms are understood to be collectively included within the meaning of reference to said element. It is further understood that a reference to any given rare earth element is inclusive of all isotopic forms of the element. In one embodiment of the present disclosure, significant concentrations of Gadolinium, Terbium, Dysprosium, Erbium, Ytterbium, and/or Lutetium are present in the coal material source 101 utilized in the system and method according to the present disclosure.

The processing of the rare earth element recovery unit 119 may utilize any suitable technique for capturing, separating, recovering and/or concentrating rare earth materials. These methods may include, for example, forming an aqueous solution containing the rare earth materials and then contacting the aqueous solution comprising the rare earth materials) with a solid sequestration media (e.g., a stabilized flue gas desulfurization (sFGD) material, or a sludge by-product from a water treatment process) to provide a REM-containing solid feedstock; and contacting the solid feedstock with an extraction solution to generate a rare earth material stream 125 having an increased concentration of rare earth material. For example, a process of recovering rare earth material may be provided and utilizing the equipment as described in U.S. Patent Publication 2022/0289585A1, published Sep. 15, 2022, which is hereby incorporated by reference in its entirety.

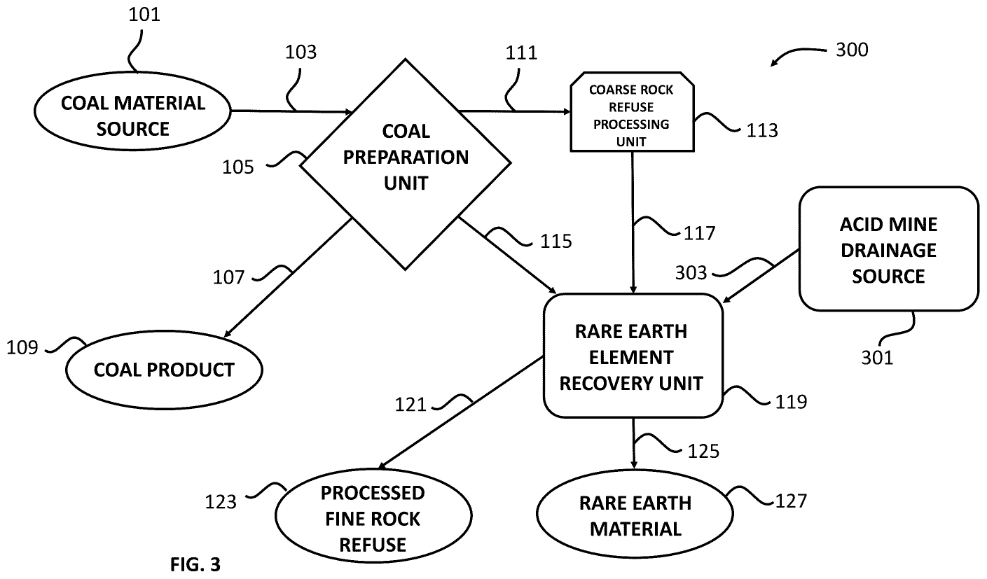

Another suitable process that may take place in the rare earth element recovery unit 119 is an extraction process utilizing supercritical CO₂. In this method, the first fine rock refuse stream 115 and the second fine rock refuse stream 117, and, optionally an acid mine drainage stream 303 (see FIG. 3), are contacted with supercritical CO₂ and an acid to form a mixture wherein metals, such as aluminum and/or iron, and precipitating a rare earth material containing composition from the mixture. For example, a process of recovering rare earth material may be provided and utilizing the equipment as described in U.S. Patent Publication 2021/0347652A1, published Nov. 11, 2021, which is hereby incorporated by reference in its entirety. In other embodiment, the process utilized by the rare earth element recovery unit may include magnets or magnetic separation technology. In other embodiment, acid bath technologies may be utilized.

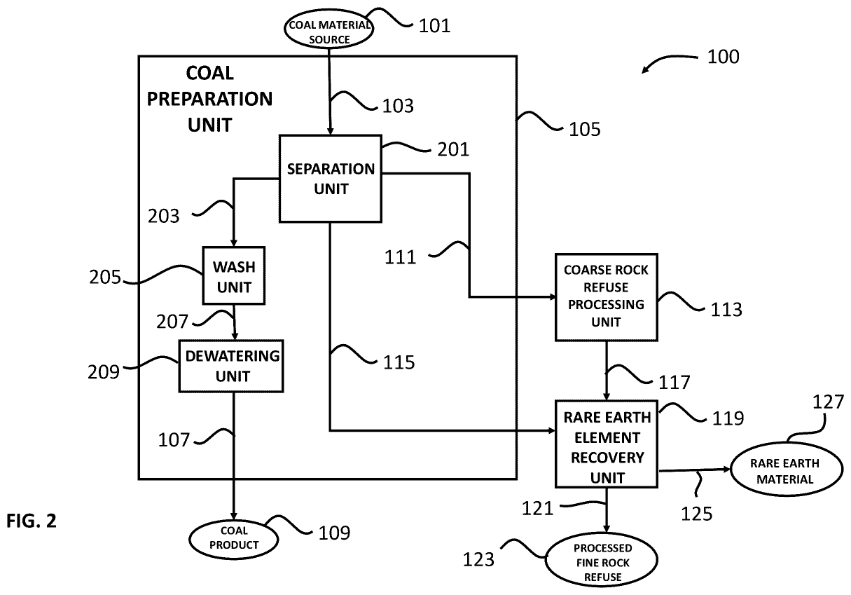

On average, an operating plant running mine refuse can potentially produce 20 ton per hour (tph) of a high carbon anthracite product in the clean prepared coal stream and have 120+ tph of feed for the rare earth element recovery system. The rare earth element recovery unit 119 then processes the fine rock refuse stream 115 and the crushed/pulverized coarse rock refuse stream 111 into a processed second fine rock refuse stream 117 and a rare earth material 127 or recovered product. The processed fine rock refuse stream 123 is an end byproduct for reclamation fill and the rare earth material 127 is a commercially valuable REM containing material stream. FIG. 2 shows another embodiment of the coal and rare earth recovery system 100 according to the present disclosure including further processing units in the coal preparation unit 105. As shown in FIG. 2, an unprepared plant feed 103 is provided from a coal material source 101. The unprepared plant feed 103 is provided to a separation unit 201 that separates where the unprepared plant feed 103 is separated and classified based on particle size and composition. This step helps to isolate the coal fines from other impurities. The separation unit 201 separates the unprepared plant feed 103 into a coarse rock refuse stream 111, a first fine rock refuse stream 115, and a product coal stream 203. In one embodiment, separation unit 201 may include a coal spiral. Coal Spirals are a suitable, effective, and inexpensive technology for separating minerals. They would most likely be implemented into the circuit outside of the spirals that clean the coal and make the fine refuse reject. The product coal stream 203 is fed to a wash unit 205, where the product coal stream 203 is washed and cleaned to remove impurities, such as sulfur, ash, and other contaminants. This can involve processes like dense medium separation, flotation, or cyclone separation. A washed product stream 207 is then fed to a dewatering unit 209 where washed product stream 207 undergo a dewatering process to reduce moisture content, which improves the efficiency of subsequent processing steps. The stream from the dewatering unit 209 is a clean prepared coal stream 107 that may be further sized and graded according to specific particle size requirements for commercial-grade coal products, such as high-grade anthracite. In some embodiments, the coal fines in the clean prepared coal stream 107 may be agglomerated or compacted into larger particles or briquettes to improve handling, transportation, and combustion properties. In addition, as shown and described in FIG. 1, the system shown in FIG. 2 includes a coarse rock refuse stream 111 that is fed to a coarse rock refuse processing unit 113. The coarse rock refuse processing unit 113 processes the coarse rock refuse stream 111 into a second fine rock refuse stream 117. The first fine rock refuse stream 115 and the second fine rock refuse stream 117 are both fed to the rare earth element recovery unit 119, where the rare earth element recovery unit 119 processes the first fine rock refuse stream 115 and the second fine rock refuse stream 117 to produce a processed fine rock refuse stream 121 that is accumulated and/or stored for disposal or reclamation as processed fine rock refuse 123.

FIG. 3 shows a coal and rare earth recovery system 300 according to another embodiment of the present disclosure. The coal and rare earth recovery system 300 includes a coal material source 101, which includes processed or mined coal materials. As described with respect to FIG. 1, the coal and rare earth recovery system 300 includes a coal preparation unit 105 that processes an unprepared plant feed 103 into separated output streams. The coal material source 101 may be a hopper or other material handling unit capable of feeding an unprepared plant feed 103 to a coal preparation unit 105. In other embodiments the coal material source 101 may be stored or piled mine refuse, such as mine culm, silt, gob, tailings, rejects, or other mine refuse that has been previously processed. The coal preparation unit 105 includes processes to clean and separate the unprepared plant feed 103 into a clean prepared coal stream 107, a coarse rock refuse stream 111, a first fine rock refuse stream 115. The coal preparation unit 105 performs processes to generate the three different streams, including the coarse rock refuse stream 111, the first fine coarse rock refuse stream 115 and the clean prepared coal stream 107. The coarse rock refuse stream 111 is fed to a coarse rock refuse processing unit 113, which crushes or otherwise processes the coarse rock refuse stream 111 into a second fine rock refuse stream 117. The second fine rock refuse stream 117 from the coarse rock refuse processing unit 113 and the first fine rock refuse stream 115 are fed to a rare earth element recovery unit 119. Unlike the coal and rare earth recovery system 100 of FIG. 1, system 300 includes an acid mine drainage (AMD) source 301, which may be water sources from active or abandoned mining operations that include drainage that has reacted with sulfides present in rocks as a result of the mining process.

An AMD stream 303 is provided to the rare earth element recovery unit 119. The rare earth element recovery unit 119 utilizes chemical and mechanical processes to recover and concentrate rare earth elements in materials to form a rare earth material stream 125 and a rare earth material 127. The rare earth element recovery unit 119 also produces a processed fine rock refuse stream 121 that is accumulated and/or stored for disposal or reclamation as processed fine rock refuse 123. In another embodiment, the AMD source 301 may be all or the majority of the feed to the rare earth element recovery unit 119. In addition, significant amounts of rare earth materials are present in water being naturally discharged by mine pools. This may take place by either entering the water directly into the rare earth element recovery system and/or be discharged into settling ponds to collect any potential particles for future refining if the volume exceeds the plants capabilities.

In other embodiments the coal material source 101 may be stored or piled mine refuse, such as mine culm, silt, gob, tailings, rejects, or other mine refuse that has been previously processed. The coal preparation unit 105 includes processes to clean and separate the unprepared plant feed 103 into a clean prepared coal stream 107, a coarse rock refuse stream 111, a first fine rock refuse stream 115. The coal preparation unit 105 performs processes to generate the three different streams, including the coarse rock refuse stream 111, the first fine coarse rock refuse stream 115 and the clean prepared coal stream 107. The coarse rock refuse stream 111 is fed to a coarse rock refuse processing unit 113, which crushes or otherwise processes the coarse rock refuse stream 111 into a second fine rock refuse stream 117. The second fine rock refuse stream 117 from the coarse rock refuse processing unit 113 and the first fine rock refuse stream 115 are fed to a rare earth element recovery unit 119. Unlike coal and rare earth recovery system 100 of FIG. 1, system 300 includes an acid mine drainage (AMD) source 301, which may be water sources from active or abandoned mining operations that include drainage that has reacted with sulfides present in rocks as a result of the mining process.

The processing of the rare earth element recovery unit 119 when an AMD stream 303 is present may utilize any suitable technique for capturing, separating, recovering and/or concentrating rare earth materials. These methods may include, for example, (a) contacting the AMD stream 303 with a first base in an amount sufficient to adjust the pH to a value from about 4.0 to about 6.0, thereby forming a mixture comprising a first aqueous phase and a first solid concentrate; (b) separating the first aqueous phase from the first solid concentrate; (c) contacting the first aqueous phase with a second base in an amount sufficient to adjust the pH to a value from about 7.0 to about 9.0, thereby forming a mixture comprising a second aqueous phase and the hydraulic pre-concentrate; (d) removing the second aqueous phase and collecting the rare earth material enriched in rare earth elements. For example, a process of recovering rare earth material from streams including the AMD stream 303 may be provided and utilizing the equipment as described in U.S. Patent Publication 2022/0340997, published Oct. 27, 2022, which is hereby incorporated by reference in its entirety.

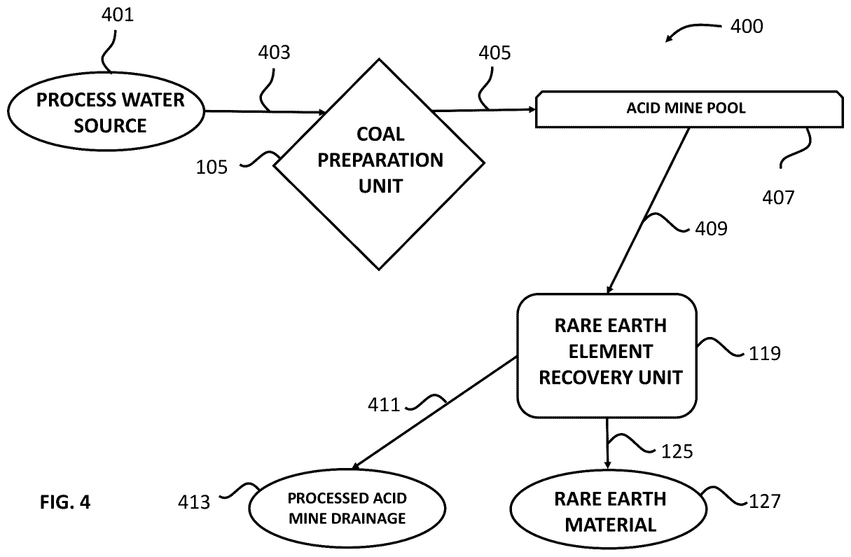

FIG. 4 shows a coal and rare earth recovery system 400 according to the present disclosure. The coal and rare earth recovery system 400 includes a process water source 401, which may include any suitable source of water for processing coal materials. For example, process water source 401 may include water from mine caverns, surface water from rivers, streams, reservoirs, lakes or other bodies of water, municipal water or other suitable sources of water. Coal and rare earth recovery system 400 includes a coal preparation unit 105 as shown and described with respect to FIG. 1. The process water source 401 is provided to the coal preparation unit 105 as process water stream 403. As shown and described with respect to FIG. 2, the process water stream 403 may be utilized in the washing or other processes in cleaning and processing the coal material into clean prepared coal. For example, in coal processing in the coal preparation unit 105, about 1,000 or more gallons of process water per minute may be utilized in the separation, cleaning, and sizing of coal. Depending on the size of the plant, additional water may be utilized. In the separation, cleaning and sizing of the coal within the coal preparation unit 105 entrains ultrafine coal particulates, which includes a particle size smaller than the first fine refuse stream 115 as shown and described with respect to FIG. 1. In one embodiment, the ultrafine coal may include a particles size smaller than-150 mesh (or less than 100 microns). In another embodiment, the ultrafine particles may have a particle size from about 1 to about 100 microns.

The coal preparation unit 105 discharges a water and ultrafine coal refuse stream 405 to an acid mine pool 407. The acid mine pool 407 is a reservoir, pond, pool or other liquid containing body that is capable of accumulating the water and ultrafine coal refuse stream 405 to allow the material to settle and/or separate over a period of time. In addition, material from the acid mine pool 407 may be absorbed back into the earth. For example, in coal processing, up to 1,000 or more gallons per minute is commonly used in the separation, cleaning, and sizing of coal. Depending on the size of the plant, additional water may be needed. In addition, significant amounts of REMS are present in water being naturally discharged by mine pools. This may take place by either entering the water directly into the coal and rare earth recovery system 400 and/or be discharged into settling ponds or acid mine pool 407 to collect any potential particles for further refining.

An acid mine drainage stream 409 from the acid mine pool 407 is fed to a rare earth element recovery unit 119. The acid mine drainage stream 409 may be withdrawn from the acid mine pool, such as via pumps, or may be collected from streams or other discharges from the acid mine pool 407. The rare earth element recovery unit 119 may include, for example, the types of processing units shown and described with respect to FIG. 3. The rare earth element recovery unit 119 utilizes chemical and mechanical processes to recover and concentrate rare earth elements in materials to form a rare earth material stream 125 and a rare earth material 127. The rare earth element recovery unit 119 also produces a processed acid mine drainage stream 411 that is accumulated and/or stored as processed acid mine drainage 413. The processed acid mine drainage 413 may be further processed or stored.

In addition, REM containing oxides may be attached or otherwise associated with rocks, plants, soil or other materials in pools or streams associated or discharged from mines or the acid mine pool 407. In addition to the acid mine drainage stream, 409, dredged material from these streams or pools may likewise be fed to the rare earth recovery unit 119 to further recover rare earth materials.

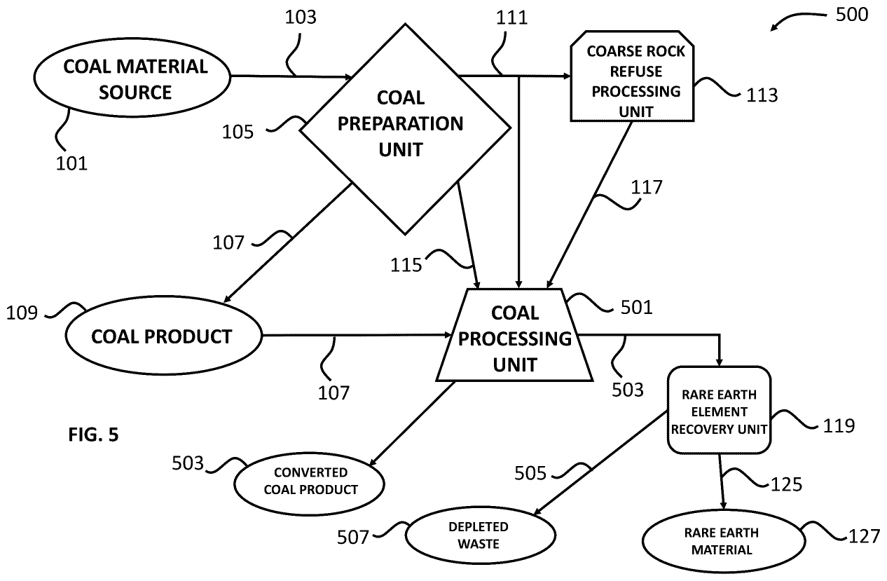

FIG. 5 shows a coal and rare earth recovery system 500 according to the present disclosure. The coal and rare earth recovery system 500 includes a coal preparation unit 105 arranged and disposed to separate a coal material source 101 into a clean prepared coal stream 107, a coarse rock refuse stream 111 and a first fine rock refuse stream 115. The coal preparation unit 105 may include the coal preparation unit 105, including the process units as shown and described with respect to FIGS. 1 and 2. As shown in FIG. 5, the system 500 includes a coal processing unit 501 arranged and disposed to receive one or more of the clean prepared coal stream 107, the coarse rock refuse stream 111 and the first fine rock refuse stream 115 and discharge a converted coal product 503 and a processed waste stream 505. The coal processing unit 501 may include any suitable equipment and/or processing to convert the coal or coal waste materials into valuable products. The coal processing unit may utilize chemical, mechanical and/or combustion processes to yield converted coal products 503. Likewise, in another embodiment, also shown in FIG. 5, a coarse rock refuse processing unit 113 may receive the coarse rock refuse stream 111 and discharge a second fine rock refuse stream 117, which is fed to the rare earth element recovery unit 119 to recover a rare earth material 127. As shown and described, for example in FIG. 1, the coarse rock refuse processing unit 113 may be a crushing mechanism to reduce the particle size of the coarse rock refuse stream 111.

For example, in one embodiment, the coal processing unit 501 is a coal to gas (CTG) or coal gasification unit that utilizes combustion processes to convert the clean prepared coal stream 107, the coarse rock refuse stream 111, the first fine rock refuse stream 115 and/or the second fine rock refuse stream 117 into the converted coal products 503. Embodiments according to the present disclosure may utilize any suitable CTG process known for converting coal products into gaseous products. In another embodiment, the coal processing unit 501 is a coal to liquid (CTL) unit that utilizes, for example, combustion. mechanical and chemical processes to convert the clean prepared coal stream 107, the coarse rock refuse stream 111, the first fine rock refuse stream 115 and/or the second fine rock refuse stream 117 into converted coal products 503. Embodiments according to the present disclosure may utilize any suitable CTL process known for converting coal products into liquid petroleum products. In another embodiment the clean prepared coal stream 107, the coarse rock refuse stream 111, the first fine rock refuse stream 115 and/or the second fine rock refuse stream 117 are fed to a chemical process that converts the input stream into the converted coal products 503. Suitable chemical processes include, but are not limited to, the chemical process for converting waste into energy available from w2e Technology, LLC (South Jordan, UT). Suitable converted coal products 503, for example from the CTG process, may include, but are not limited to, carbon monoxide (CO), hydrogen (H₂), carbon dioxide (CO₂), methane (CH₄), and water vapor (H₂O). Other suitable converted coal products, such as from the GTL process, may include liquid petroleum products, such as diesel, gasoline, or synthetic fuel (synfuel). Other suitable converted coal products, such as from the chemical process, may include, for example, hydrogen (H₂) and carbon dioxide (CO₂).

The processed waste stream 503 from the coal processing unit 501 is fed to the rare earth recovery unit 119, where the processed waste stream 503 is processed to recover rare earth material 127 discharging a rare earth material stream 125 and a depleted waste stream 505. The depleted waste 507 from the depleted waste stream may be further processed, stored, or disposed as waste. The rare earth element recovery unit 119 may include, for example, the types of processing units shown and described with respect to FIG. 1. The rare earth element recovery unit 119 utilizes chemical and mechanical processes to recover and concentrate rare earth elements in materials to form a rare earth material stream 125 and a rare earth material 127.

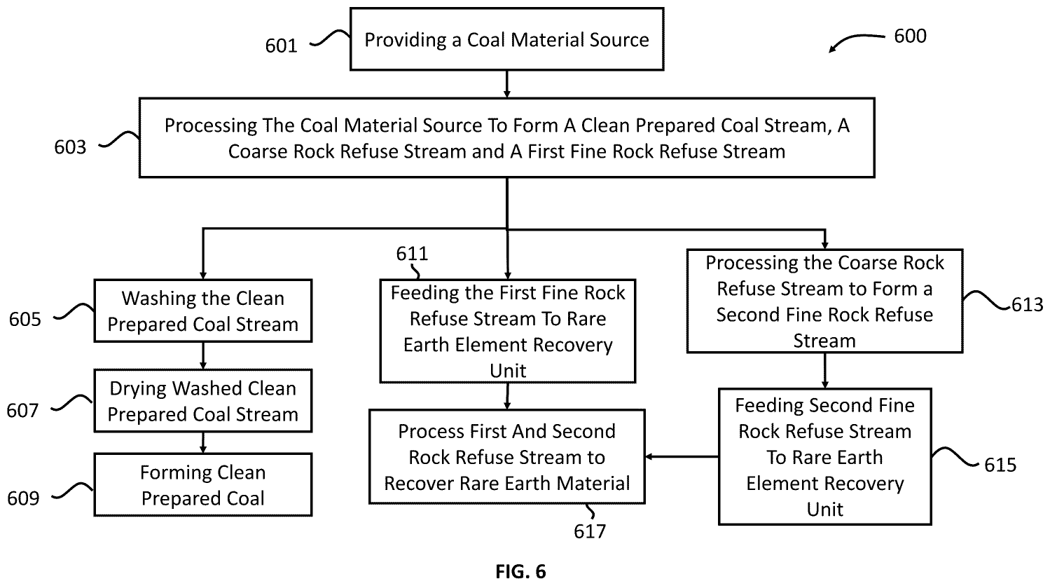

FIG. 6 shows a process flow chart illustrating a coal and rare earth recovery method 600 according to embodiment of the present disclosure. The method includes providing a coal material source, step 601. The coal material source is processed or otherwise separated into a clean prepared coal stream, a coarse rock refuse stream and a first fine rock refuse stream, step 603. The clean prepared coal stream is washed to form a washed clean prepared coal stream, step 605. The washed clean prepare coal stream is dewatered to reduce moisture content, step 607. The dewatered clean prepared coal stream is then formed by sizing and/or grading the prepared coal stream into a prepared coal suitable as a commercial coal product, step 609. The first fine rock refuse stream is fed to a rare earth element recovery unit, step 611. The coarse rock refuse stream is processed to form a second fine rock refuse stream, step 613. The second fine rock refuse stream is fed to the rare earth element recovery unit, step 615. Finally, the first and second fine rock refuse streams are processed to recover a rare earth material, step 617.

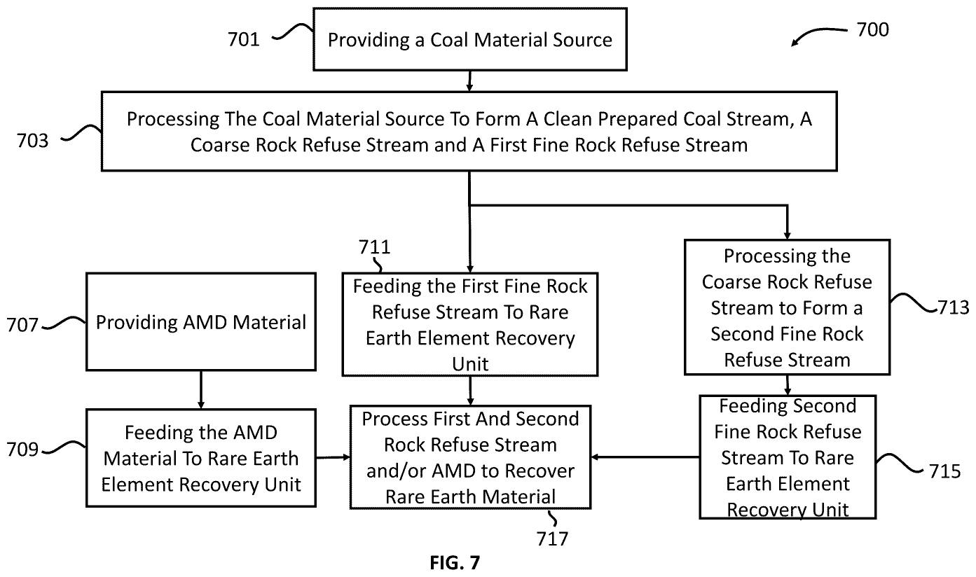

FIG. 7 shows a process flow chart illustrating a coal and rare earth recovery method 700 according to embodiment of the present disclosure. The method includes providing a coal material source, step 701. The coal material source is processed or otherwise separated into a clean prepared coal stream, a coarse rock refuse stream and a first fine rock refuse stream, step 703. An acid mine drainage material (AMD) is provided from an acid mine drainage source 301, such as from a retention pond, a mine discharge, or other AMD storage location, step 707. The AMD material is fed to a rare earth element recovery unit, step 709. The first fine rock refuse stream is also fed to the rare earth element recovery unit, step 711. The coarse rock refuse stream from is processed to form a second fine rock refuse stream, step 713. The second fine rock refuse stream is fed to the rare earth element recovery unit, step 715. Finally, the first fine rock refuse stream, the second fine rock refuse stream and/or the AMD material are processed to form a rare earth material, step 717.

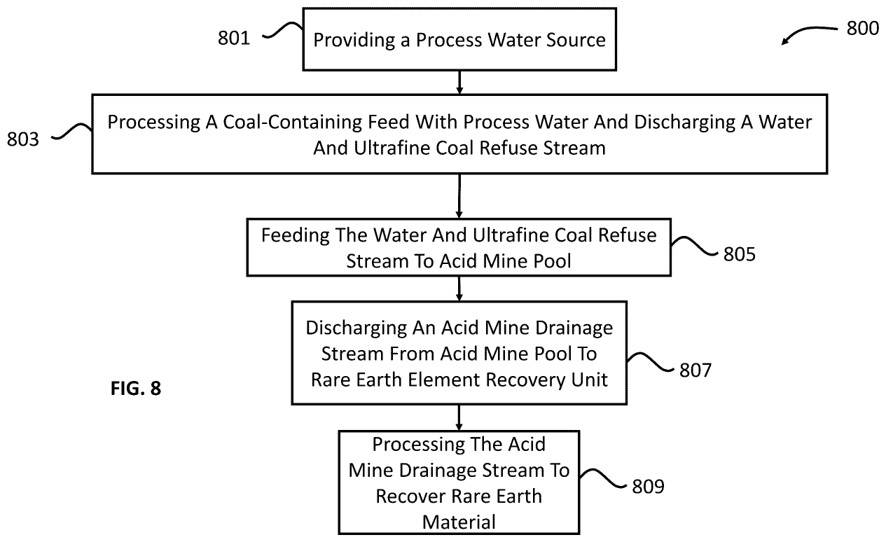

FIG. 8 shows a process flow chart illustrating a coal and rare earth recovery method 800 according to embodiment of the present disclosure. The method includes providing a process water source, step 801. A coal containing feed is processed with process water from the process water source and a water and ultrafine coal refuse stream is discharged, step 803. The water and ultrafine coal refuse stream are fed to an acid mine pool, step 805. An acid mine drainage stream is discharged from the acid mine pool to a rare earth element recovery unit, step 807. The acid mine drainage steam is processed with the rare earth element recovery unit to recover rare earth material, step 809.

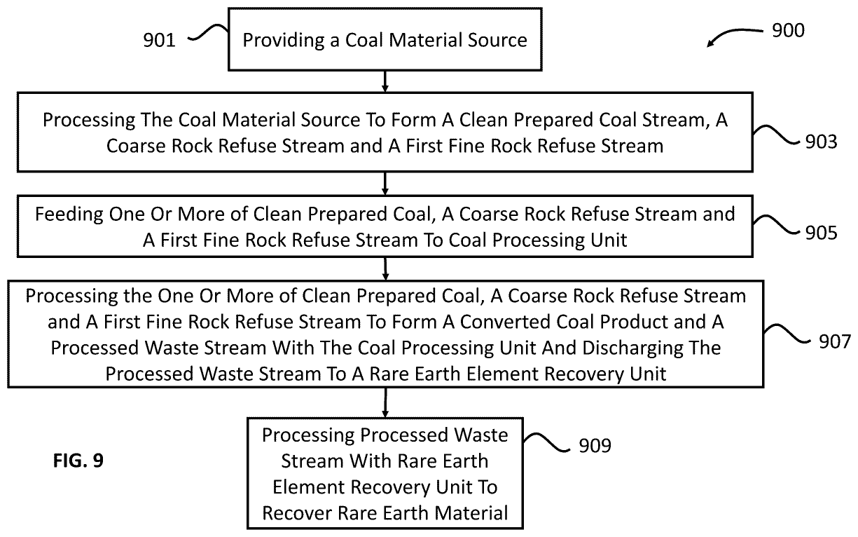

FIG. 9 shows a process flow chart illustrating a coal and rare earth recovery method 900 according to embodiment of the present disclosure. The method includes providing a coal material source, step 901. The coal material source is processed to form a clean prepared coal stream, a coarse rock refuse stream and a first fine rock refuse stream, step 903. One or more of the clean prepared coal stream, the coarse rock refuse stream and the first fine rock refuse stream are fed to a coal processing unit, step 905. The one or more of the clean prepared coal stream, the coarse rock refuse stream and the first fine rock refuse stream are processed with the coal processing unit and the processed waste stream is discharged to a rare earth element recovery unit, step 907. In another embodiment, as shown and described with respect to FIG. 5, the coarse rock refuse stream may be further processed by a coarse rock refuse processing unit to form a second fine rock refuse stream, which may be fed to the coal processing unit. The processed waste stream is processed with the rare earth element recovery unit to recover rare earth material, step 909.

While the exemplary embodiments illustrated in the figures and described herein are presently preferred, it should be understood that these embodiments are offered by way of example only. Accordingly, the present application is not limited to a particular embodiment, but extends to various modifications that nevertheless fall within the scope of the appended claims. The order or sequence of any processes or method steps may be varied or re-sequenced according to alternative embodiments.

It is important to note that the construction and arrangement of the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes, and omissions may be made in the design, operating conditions and arrangement of the exemplary embodiments without departing from the scope of the present application.

1. A coal and rare earth recovery system to recover rare earth materials from coal material source comprising:
a coal preparation unit arranged and disposed to process a coal material source into a clean prepared coal stream, a coarse rock refuse stream and a first fine rock refuse stream;
a coarse rock refuse processing unit arranged and disposed to receive the coarse rock refuse stream and discharge a second fine rock refuse stream; and
a rare earth element recovery unit to process the first fine rock refuse stream and the second fine rock refuse stream to recover a rare earth material.

2. The coal and rare earth recovery system according to claim 1, wherein the coarse rock refuse processing unit is a crushing mechanism.

3. The coal and rare earth recovery system according to claim 1, wherein the first fine rock refuse stream and the second fine rock refuse stream are from coal waste.

4. The coal and rare earth recovery system according to claim 1, wherein the first fine rock refuse stream and the second fine rock refuse stream are from anthracite coal waste.

5. The coal and rare earth recovery system according to claim 1, wherein the rare earth element recovery unit utilizes exposure to supercritical CO₂ to process the first fine rock refuse stream and the second fine rock refuse stream to recover the rare earth material.

6. The coal and rare earth recovery system according to claim 1, wherein the rare earth element recovery unit utilizes exposure to solid sequestration agent to process the first fine rock refuse stream and the second fine rock refuse stream to recover the rare earth material.

7. The coal and rare earth recovery system according to claim 1, further comprising an acid mine drainage source, the acid mine drainage source being provided to the rare earth element recovery unit.

8. A method for coal and rare earth recovery comprising:
providing a coal material feed;
separating the coal material feed to produce a clean prepared coal stream, a coarse rock refuse stream and a first fine rock refuse stream;
washing the clean prepared coal stream to form a washed clean prepared coal stream;
dewatering the washed clean prepared coal stream to form a clean prepared coal; and
processing the coarse rock refuse stream to form a second fine rock refuse stream;
wherein the first fine rock refuse stream and the second fine rock refuse stream are fed to a rare earth element recovery unit to process the first fine rock refuse stream and the second fine rock refuse stream to recover a rare earth material.

9. The method according to claim 8, wherein the processing of the coarse rock refuse stream includes crushing the coarse rock refuse stream to form material having reduced particle size.

10. The method according to claim 8, wherein the rare earth element recovery unit utilizes exposure to supercritical CO₂ to process the first fine rock refuse stream and the second fine rock refuse stream to recover the rare earth material.

11. The method according to claim 8, wherein the rare earth element recovery unit utilizes exposure to solid sequestration agent to process the first fine rock refuse stream and the second fine rock refuse stream to recover the rare earth material.

12. The method according to claim 8, further comprising an acid mine drainage source, an acid mine drainage stream from the acid mine drainage source being provided to the rare earth element recovery unit.

13. The method according to claim 8, wherein the coal material feed is coal waste.

14. The method according to claim 8, wherein the coal material feed includes anthracite coal waste.

15. The method according to claim 8, wherein the coal material feed is mined coal.

16. A coal and rare earth recovery system to recover rare earth materials from a coal material source comprising:
a process water source;
a coal preparation unit arranged and disposed to receive a process water stream from the process water source to process a coal material feed and discharge a water and ultrafine coal refuse stream;
acid mine pool arranged and disposed to receive the water and ultrafine coal refuse stream from the coal preparation unit; and
a rare earth element recovery unit arranged and disposed to process an acid mine drainage stream from the acid mine pool to recover a rare earth material.

17. The coal and rare earth recovery system according to claim 16, wherein the rare earth element recovery unit utilizes exposure to supercritical CO₂ to process the first fine rock refuse stream and the second fine rock refuse stream to recover the rare earth material.

18. The coal and rare earth recovery system according to claim 16, wherein the rare earth element recovery unit utilizes exposure to solid sequestration agent to process the first fine rock refuse stream and the second fine rock refuse stream to recover the rare earth material.

19. A method for coal and rare earth recovery comprising:
providing a process water source;
processing a coal material feed with a coal preparation unit, the coal preparation unit discharging a water and ultrafine coal refuse stream to an acid mine pool;
feeding an acid mine drainage stream from the acid mine pool to a rare earth element recovery unit;
processing the acid mine drainage stream with the rare earth element recovery unit to recover a rare earth material.

20. The method according to claim 19, wherein the rare earth element recovery unit utilizes exposure to supercritical CO₂ to process the first fine rock refuse stream and the second fine rock refuse stream to recover the rare earth material.

21. The method according to claim 19, wherein the rare earth element recovery unit utilizes exposure to solid sequestration agent to process the first fine rock refuse stream and the second fine rock refuse stream to recover the rare earth material.

22. The method according to claim 19, wherein dredged material from the acid mine pool is fed to the rare earth recovery unit.

23. A coal and rare earth recovery system to recover rare earth materials from coal material source comprising:
a coal preparation unit arranged and disposed to separate a coal material source into a clean prepared coal stream, a coarse rock refuse stream and a first fine rock refuse stream;
a coal processing unit arranged and disposed to receive one or more of the clean prepared coal stream, the coarse rock refuse stream and the first fine rock refuse stream and discharge a converted coal product and a processed waste stream; and
a rare earth element recovery unit arranged and disposed to process the processed waste stream to recover a rare earth material.

24. A coal and rare earth recovery system according to claim 23, further comprising a coarse rock refuse processing unit arranged and disposed to receive the coarse rock refuse stream and discharge a second fine rock refuse stream, wherein the second fine rock refuse stream is fed to the rare earth element recovery unit to recover a rare earth material.

25. The coal and rare earth recovery system according to claim 24, wherein the coarse rock refuse processing unit is a crushing mechanism.

26. The coal and rare earth recovery system according to claim 23, wherein the first fine rock refuse stream and the second fine rock refuse stream are from coal waste.

27. The coal and rare earth recovery system according to claim 23, wherein the first fine rock refuse stream and the second fine rock refuse stream are from anthracite coal waste.

28. A coal and rare earth recovery system according to claim 23, wherein the coal processing unit is selected from the group consisting of a chemical process unit, a coal-to-gas process unit, a coal-to-liquid process unit or a combination thereof to convert the one or more of the clean prepared coal stream, the coarse rock refuse stream and the first fine rock refuse stream to a converted coal product and a processed waste stream.

29. A coal and rare earth recovery system according to claim 23, wherein the coal processing unit utilizes a process selected from the group consisting of a chemical process, a mechanical process, a combustion process and combinations thereof to convert the one or more of the clean prepared coal stream, the coarse rock refuse stream and the first fine rock refuse stream to a converted coal product and a processed waste stream.

30. A method for recovering coal and rare earth material from coal material source comprising:
separating a coal material source into a clean prepared coal stream, a coarse rock refuse stream and a first fine rock refuse stream;
processing one or more of the clean prepared coal stream, the coarse rock refuse stream, the fine rock refuse stream to form a converted coal product and a processed waste stream; and
processing the processed waste stream with a rare earth element recovery unit to recover a rare earth material.

31. The method according to claim 30, wherein the processing includes processing with a process unit selected from the group consisting of a chemical process unit, a coal-to-gas process unit, a coal-to-liquid process unit or a combination thereof, to convert the one or more of the clean prepared coal stream, the coarse rock refuse stream and the first fine rock refuse stream to a converted coal product and a processed waste stream.

32. The method according to claim 30, wherein the processing includes a process selected from the group consisting of a chemical process, a mechanical process, a combustion process and combinations thereof, to convert the one or more of the clean prepared coal stream, the coarse rock refuse stream and the first fine rock refuse stream to a converted coal product and a processed waste stream.

33. The method according to claim 30, wherein the rare earth element recovery unit utilizes exposure to supercritical CO₂ to process the first fine rock refuse stream and the second fine rock refuse stream to recover the rare earth material.

34. The method according to claim 30, wherein the rare earth element recovery unit utilizes exposure to solid sequestration agent to process the first fine rock refuse stream and the second fine rock refuse stream to recover the rare earth material.

35. The method according to claim 30, wherein the coal material source is coal waste.

36. The method according to claim 30, wherein the coal material source includes anthracite coal waste.

37. The method according to claim 30, wherein the coal material source is mined coal.
